(19) United States
(12) Patent Application Publication
(10) Pub. No.: US 2022/0198420 A1
(43) Pub. Date: Jun. 23, 2022

(54) SELF-CHECKOUT SYSTEMS USING OVERLAPPING DISPLAY DEVICES

(71) Applicant: Toshiba Global Commerce Solutions Holdings Corporation, Tokyo (JP)

(72) Inventors: Adrian X. RODRIGUEZ, Durham, NC (US); Brad M. JOHNSON, Raleigh, NC (US)

(21) Appl. No.: 17/125,530

(22) Filed: Dec. 17, 2020

(51) Int. Cl. G06Q 20/20; G06F 3/14; G07G 1/01; G06F 3/0488

(52) U.S. Cl. CPC G06Q 20/202; G06Q 20/209; G06F 3/0488; G07G 1/01; G06F 3/1423

(57) ABSTRACT

Aspects described herein include a system, method, and computer program product for electronic completion of a transaction. The system comprises a first display device, a second display device that is at least partly overlapped by the first display device, and a touch input device. The system further comprises one or more computer processors configured to display one or more graphical elements using the first display device, and display, responsive to a first input signaling that the transaction is to be electronically completed, one or more user interface (UI) elements using the second display device. The one or more UI elements are viewable through an optically transmissive portion of the first display device. The one or more computer processors are further configured to receive, using the touch input device, at least a second input while the one or more UI elements are displayed.

### BACKGROUND

The present disclosure relates to self-checkout systems using overlapping display devices.

Self-checkout systems include diverse functionality that enables a customer to perform some or all of the stages of a self-checkout transaction, such as scanning items, weighing items, bagging items, presenting payment, and providing a paper or electronic receipt. However, consolidating or streamlining the functionality of self-checkout systems may be challenging, as security considerations may require isolation of hardware systems supporting different functions. For example, the Payment Card Industry (PCI) Security Standards Council maintains a PCI Data Security Standard (DSS) to ensure that credit card information entered by a customer is securely processed, stored, and transmitted. To ensure PCI DSS compliance, a self-checkout system may isolate a payment system (e.g., credit card reader and/or pinpad) from the other hardware of the point-of-sale (POS) terminal.

### SUMMARY

According to one embodiment, a system is disclosed for electronic completion of a transaction. The system comprises a first display device, a second display device that is at least partly overlapped by the first display device, a touch input device, and one or more computer processors that are configured to display one or more graphical elements using the first display device. The one or more computer processors are further configured to display, responsive to a first input signaling that the transaction is to be electronically completed, one or more user interface (UI) elements using the second display device. The one or more UI elements are viewable through an optically transmissive portion of the first display device. The one or more computer processors are further configured to receive, using the touch input device, at least a second input while the one or more UI elements are displayed.

According to another embodiment, a computer-implemented method is described of electronic completion of a transaction. The method comprises displaying, using a first display device, one or more graphical elements, and receiving a first input signaling that the transaction is to be electronically completed. The method further comprises displaying, responsive to the first input, one or more user interface (UI) elements using a second display device that is at least partly overlapped by the first display device. The one or more UI elements are viewable through an optically transmissive portion of the first display device. The method further comprises receiving, using a touch input device, at least a second input while the one or more UI elements are displayed.

According to another embodiment, a computer program product is described for electronic completion of a transaction. The computer program product comprises a computer-readable storage medium having computer-readable program code. The computer-readable program code is executable by one or more computer processors to perform an operation that comprises displaying, using a first display device coupled with the one or more computer processors, one or more graphical elements. The operation further comprises receiving a first input signaling that the transaction is to be electronically completed, and displaying, responsive to the first input, one or more user interface (UI) elements using a second display device coupled with the one or more computer processors and that is at least partly overlapped by the first display device. The one or more UI elements are viewable through an optically transmissive portion of the first display device. The operation further comprises receiving, using a touch input device coupled with the one or more computer processors, at least a second input while the one or more UI elements are displayed.

### BRIEF DESCRIPTION OF THE SEVERAL VIEWS OF THE DRAWINGS

So that the manner in which the above recited aspects are attained and can be understood in detail, a more particular description of embodiments of the disclosure, briefly summarized above, may be had by reference to the appended drawings. It is to be noted, however, that the appended drawings illustrate only typical embodiments of the disclosure and are therefore not to be considered limiting of its scope, for the disclosure may admit to other equally effective embodiments.

FIG. 1 illustrates an exemplary implementation of a self-checkout system with bagging stations, according to one or more embodiments.

FIG. 2A illustrates displaying graphical elements using a first display device of a self-checkout system, according to one or more embodiments.

FIG. 2B illustrates displaying payment user interface (UI) elements using a second display device of a self-checkout system, according to one or more embodiments.

FIG. 2C illustrates displaying payment user interface (UI) elements using a second display device of a self-checkout system, according to one or more embodiments.

FIG. 2D illustrates displaying payment user interface (UI) elements using a second display device of a self-checkout system, according to one or more embodiments.

FIG. 3 is a block diagram of a system having multiple touch input layers, according to one or more embodiments.

FIG. 4 is a block diagram of a system having a shared touch input layer, according to one or more embodiments.

FIG. 5A is an arrangement of display devices with coextensive active areas, according to one or more embodiments.

FIG. 5B is an arrangement of display devices with coextensive active areas, according to one or more embodiments.

FIG. 5C is an arrangement of display devices with non-coextensive active areas, according to one or more embodiments.

FIG. 5D is an arrangement of display devices with non-coextensive active areas, according to one or more embodiments.

FIG. 5E is an arrangement of display devices with non-overlapping active areas, according to one or more embodiments.

FIG. 5F is an arrangement of display devices with non-overlapping active areas, according to one or more embodiments.

FIG. 6 is a method of electronic completion of a sale transaction, according to one or more embodiments.

### DETAILED DESCRIPTION

Aspects of the current disclosure relate to a system for electronic completion of a transaction. The system comprises a first display device, a second display device that is at least partly overlapped by the first display device, and a touch input device. The system further comprises one or more computer processors configured to display one or more graphical elements using the first display device, and to display, responsive to a first input signaling that the transaction is to be electronically completed, one or more user interface (UI) elements using the second display device. The one or more UI elements are viewable through an optically transmissive portion of the first display device. The one or more computer processors are further configured to receive, using the touch input device, at least a second input while the one or more UI elements are displayed.

In some embodiments, the transaction is a sale transaction (e.g., a self-checkout transaction) and the one or more UI elements comprise payment UI elements. In some embodiments, the first display device and the second display device having active areas that are partly or fully overlapping. The active area of the first display device may be selectively optically transmissive, such as an organic light-emitting diode (OLED), a side-lit liquid crystal display (LCD), or a naturally-lit LCD. In this way, the active area of the first display device may be operated in a non-transmissive state when displaying the one or more graphical elements, and may be operated in a transmissive state when displaying the one or more payment UI elements from beneath the first display device. In some embodiments, an optically transmissive portion of the first display device, such as a glass layer, overlaps an active area of the second display device.

In some embodiments, the graphical element(s) displayed by the first display device may be altered when displaying the payment UI element(s) by the second display device. For example, the first display device may be disabled, or the graphical element(s) may be frozen and/or deemphasized. In this way, the payment UI element(s) may be emphasized for viewing by the customer.

The touch input device may be integrated into the first display device or the second display device, or may be a separate device. In some embodiments, the first display device may have a first touch input device, and the second display device may have a second touch input device.

In some embodiments, displaying the one or more payment UI elements comprises disabling the first touch input device of the first display device and/or enabling the second touch input device. In some embodiments, displaying the one or more payment UI elements comprises decoupling the touch input device from a processor of the first display device and/or coupling the touch input device to a processor of the second display device (e.g., using a switch controlled by a host processor).

Beneficially, using the overlapping first display device and the second display device may streamline the implemented of the self-checkout system, as the self-checkout system appears as a singular customer interface while maintaining an isolation of the payment system for security compliance.

While features of the self-checkout system are generally discussed within the context of a shopping environment, such as a retail store, it is contemplated that the techniques disclosed herein may be applied to other environments (some non-limiting examples include libraries, museums, classrooms, hospitals, etc.).

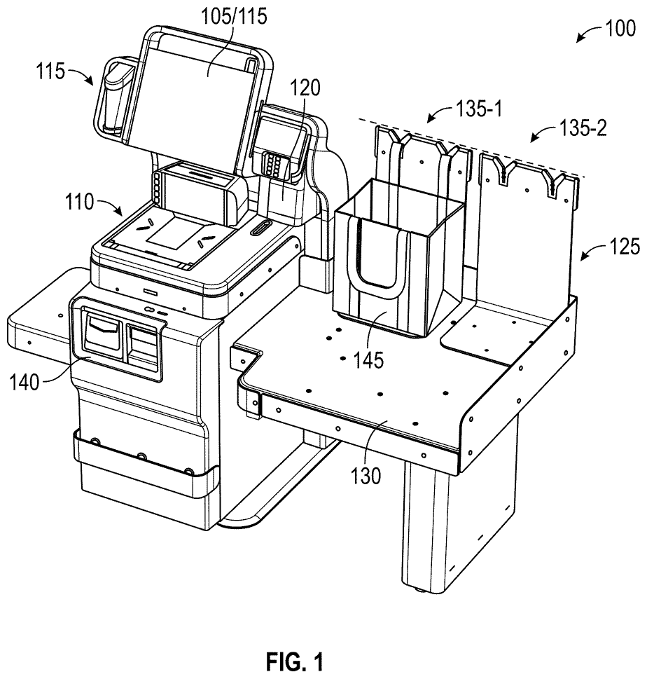

FIG. 1 illustrates an exemplary implementation of a self-checkout system 100 with bagging stations 135-1, 135-2, according to one or more embodiments. The self-checkout system 100 generally has functionality that enables a customer to perform some or all of the stages of a self-checkout transaction, such as scanning items, weighing items, bagging items, presenting payment, and providing a paper or electronic receipt

The self-checkout system 100 comprises a display system 105 that presents information viewable by a user (e.g., a customer or an associate) during various stages of a self-checkout transaction. The display system 105 is communicatively coupled with one or more computer processors, which may be integrated into the self-checkout system 100 or external to the self-checkout system 100. For example, the one or more computer processors may be included in a computing device integrated with the self-checkout system 100, which may be further networked with other computing devices. In some embodiments, the display system 105 comprises multiple, overlapping display screens using any suitable display technology or technologies, such as a liquid crystal display (LCD), an organic light-emitting diode (OLED) display, and so forth. In some embodiments, the display system 105 receives inputs from the user during the self-checkout transaction. For example, the display system 105 may include a touch-sensitive screen using any suitable sensing technology, such as capacitive sensing, resistive sensing, and so forth.

The self-checkout system 100 further comprises an item scanner 110. The item scanner 110 is communicatively coupled with the one or more computer processors, and in conjunction with the one or more computer processors visually identifies items during scanning. For example, the item scanner 110 may detect encoded portions (e.g., a Universal Product Code (UPC) or a Quick Response (QR) code) and/or may compare imagery of the item with reference image(s) to identify a type of the item. In some embodiments, the item scanner 110 may further include one or more load cells for measuring weights of items.

The self-checkout system 100 further comprises a payment receiver 115 that is fully or partly integrated into the display system 105. In some embodiments, the payment receiver 115 is fully integrated into the display system 105 (e.g., a touch input device within the display system 105). In other embodiments, the payment receiver 115 is partly integrated into the display system 105. In one example, the touch input device may provide a pinpad for a credit card terminal that is external to the display system 105. In another example, the payment receiver 115 may include a cash receiver 140 that is configured to receive banknotes and/or coins from a customer as payment for the self-checkout transaction. In some cases, the cash receiver 140 may be configured to dispense banknotes and/or coins to the customer as change.

The self-checkout system 100 further comprises a printer 120 that prints or otherwise provides tangible item(s) to the user. The printer 120 is communicatively coupled with the one or more computer processors. In some embodiments, the printer 120 generates paper receipts for the self-checkout transaction and/or coupons.

The self-checkout system 100 further comprises a bagging area 125 comprising a plurality of bagging stations 135-1, 135-2 (collectively or generically, bagging station(s) 135). Each bagging station 135 includes structure suitable for dispensing, supporting, suspending, and/or retaining single-use shopping bags and/or reusable bags or totes. As shown, the bagging stations 135-1, 135-2 are disposed on a fixed platform 130, and the bagging station 135-1 is engaged with a handle of a reusable tote 145 to retain the reusable tote 145 on the fixed platform 130. Other configurations of the bagging area 125 are also contemplated, such as different numbers and/or arrangements of the bagging stations 135, a rotatable carousel, and so forth.

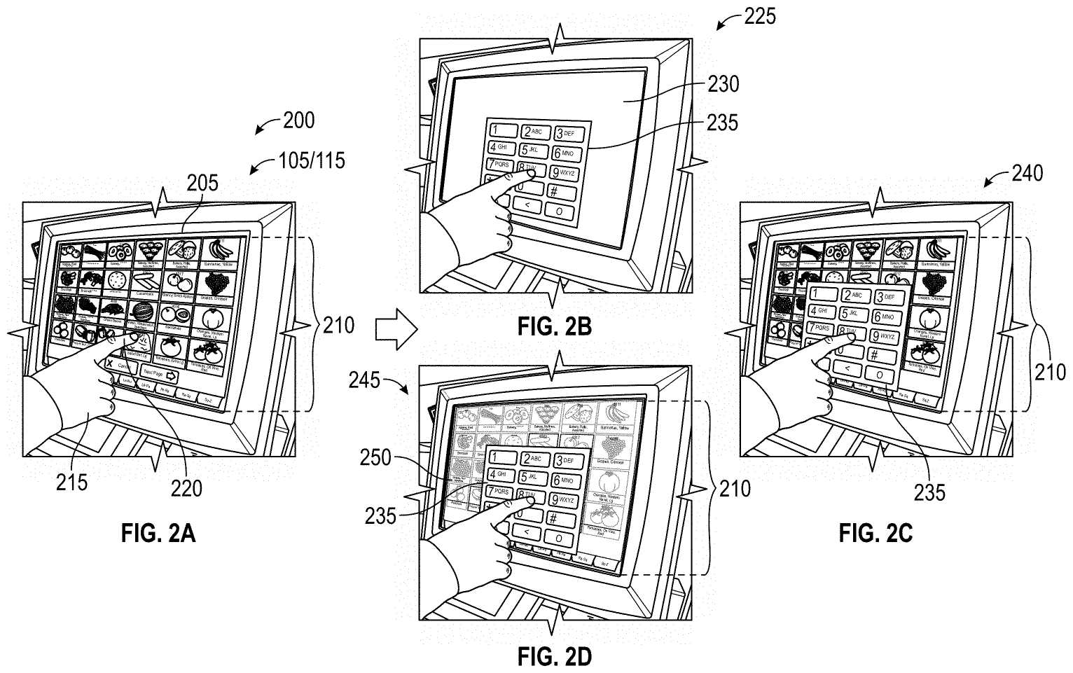

FIG. 2A illustrates displaying graphical elements using a first display device of a self-checkout system, according to one or more embodiments. In diagram 200, a user interface of the self-checkout system is shown (e.g., a top surface 205 of the display system 105). A first display device of the self-checkout system displays one or more graphical elements 210 that are viewable through the top surface 205. The graphical elements 210 may have any suitable form(s), such as geometric shapes, text, images, video, and so forth. In some embodiments, the one or more graphical elements 210 display information related to a sale transaction. For example, as shown in the diagram 200, the one or more graphical elements 210 include an array of virtual buttons corresponding to different selectable items and/or to different administrative functions related to the sale transaction. Other types of information may be depicted by the one or more graphical elements 210, which may include information that is not representative of the sale transaction (e.g., advertising).

A user 215 may update the sale transaction by providing inputs to the self-checkout system. In some embodiments, the sale transaction may be updated by presenting and/or scanning items at the self-checkout system (e.g., which results in the items being added to a virtual shopping cart associated with the user 215). In some embodiments, the sale transaction may also be updated prior to the user 215 interacting with the self-checkout system. For example, the virtual shopping cart may be updated as the user 215 transits the environment (e.g., responsive to the user 215 selecting items off a shelf and/or adding items to a shopping receptacle).

In some embodiments, the user 215 may update the sale transaction by providing inputs at the user interface (e.g., presses of a finger 220 at the top surface 205). For example, the user 215 may press a virtual button corresponding to a selectable item, which causes the selectable item to be added to the virtual shopping cart associated with the user 215.

In some embodiments, the user 215 may press a virtual button to provide an input to the self-checkout system signaling that the sale transaction is to be electronically completed. Generally, the user 215 may provide the input to begin electronic completion of the sale transaction when the virtual shopping cart includes all of the items that are desired by the user 215. In this way, the input to the self-checkout system may indicate an intent of the user 215 to electronically complete the sale transaction by presenting payment. In alternate embodiment, the user 215 may perform a predefined gesture, which is captured by a visual sensor of the self-checkout system, to signal that the sale transaction is to be electronically completed. In another alternate embodiment, the self-checkout system may automatically determine that the sale transaction is to be electronically completed, e.g., when all of the items presented by the user 215 have been scanned.

Responsive to the input, the self-checkout system displays one or more payment user interface (UI) elements 235 using a second display device of the self-checkout system that is overlapped by the first display device. In some cases, the second display device is further from the top surface 205 than the first display device. As shown, the one or more payment UI elements 235 are displayed as a pinpad, although other forms are also contemplated. For example, the one or more payment UI elements 235 may perform additional functionality related to electronically completing the sale transaction. The one or more payment UI elements 235 are viewable through an optically transmissive portion of the first display device and through the top surface 205.

In some embodiments, an active area of the first display device is selective optically transmissive, and the one or more payment UI elements 235 are displayed when the active area (or at least, an overlapping area of the active area with an active area of the second display device) is in a transmissive state. In other embodiments, an optically transmissive portion of the first display device overlaps an active area of the second display device.

The self-checkout system may emphasize the one or more payment UI elements 235 relative to the one or more graphical elements 210, which tends to cause the attention of the user 215 to be attracted to the one or more payment UI elements 235. In some embodiments, displaying the one or more payment UI elements 235 comprises at least one of disabling the first display device, freezing the one or more graphical elements 210 displayed by the first display device, or deemphasizing the one or more graphical elements 210 displayed by the first display device.

Although discussed primarily in terms of electronic completion of a sale transaction, the techniques herein may be applied to perform any suitable type of transaction. In some embodiments, an input at the user interface signals that the transaction is to be electronically completed, and one or more UI elements are displayed. In one example, the display system 105 may be implemented in a coupon kiosk and the UI elements comprise a pinpad for entering customer identification information, such as a phone number. In another example, the display system 105 may be implemented in a return system.

FIGS. 2B, 2C, and 2D illustrate displaying the one or more payment UI elements 235 using the second display device, which in some cases is responsive to the input signaling that the sale transaction is to be electronically completed. In diagram 225 of FIG. 2B, the one or more graphical elements 210 are not viewable at the top surface 205. In some embodiments, the first display device may be disabled (e.g., powered down) to darken the area 230 surrounding the one or more payment UI elements 235. In some embodiments, the first display device may be operated in a transmissive state, permitting the one or more payment UI elements 235 to be transmitted through the first display device and through the top surface 205. In some embodiments, the pixels of the first display device corresponding to the area 230 are driven with a dark color (e.g., black).

In diagram 240 of FIG. 2C, the one or more graphical elements 210 are viewable at the top surface 205. In some embodiments, the portion of the first display device overlapping the one or more graphical elements 210 may be operated in a transmissive state. In some embodiments, the one or more graphical elements 210 may be frozen while the one or more payment UI elements 235 are displayed. For example, the one or more graphical elements 210 may be statically displayed and/or inputs applied at the top surface 205 to the one or more graphical elements 210 may be disabled while the one or more payment UI elements 235 are displayed.

In diagram 245 of FIG. 2D, the one or more graphical elements 210 are viewable and deemphasized. For example, the area 250 surrounding the one or more payment UI elements 235 may be grayed out, obscuring the visibility of the one or more graphical elements 210 by altering the color information of the one or more graphical elements 210. In another example, the pixels of the area 250 may be displayed with reduced brightness.

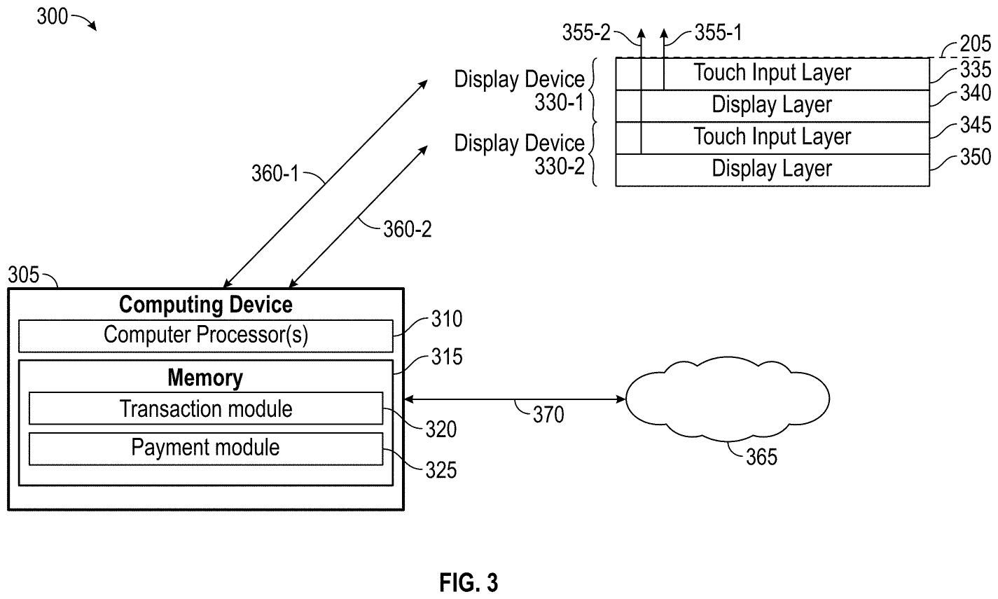

FIG. 3 is a block diagram of a system 300 having multiple touch input layers, according to one or more embodiments. The system 300 may be used in conjunction with other embodiments. For example, the system 300 may represent one implementation of the display system 105 and the payment receiver 115 of FIG. 1.

The system 300 comprises a computing device 305 having one or more computer processors 310 and a memory 315. The computing device 305 is connected with a display device 330-1 via a communicative link 360-1, and with a display device 330-2 via a communicative link 360-2. The computing device 305 is also connected with a network 365 via a communicative link 370.

The network 365 represents one or more networks of any suitable types, such as the Internet, a local area network (LAN), a wide area network (WAN), and/or a wireless network. Each of the communicative links 360-1, 360-2, 370 may have any suitable implementation, such as copper transmission cable(s), optical transmission fiber(s), wireless transmission, router(s), firewall(s), switch(es), gateway computer(s), and/or edge server(s).

The one or more computer processors 310 may be implemented in any suitable form, such as a general purpose microprocessor, a controller, an application-specific integrated circuit (ASIC), and so forth. The memory 315 may include a variety of computer-readable media selected for their size, relative performance, or other capabilities: volatile and/or non-volatile media, removable and/or non-removable media, etc.

The memory 315 may include one or more modules for performing various functions described herein. In one embodiment, each module includes program code that is executable by the one or more computer processors 310. In another embodiment, each module is partially or fully implemented in hardware (i.e., circuitry) or firmware of the computing device 305 (e.g., as circuitry within the one or more computer processors 310). However, other embodiments of the system 300 may include modules that are partially or fully implemented in other hardware or firmware, such as hardware or firmware included in one or more other computing devices connected with the network 365, and so forth. Stated another way, the overall functionality of the one or more modules may be distributed among other devices of the system 300.

As shown, the memory 315 comprises a transaction module 320 and a payment module 325. The transaction module 320 generally receives information related to the virtual shopping cart (e.g., via the network 365, a touch input layer 335, and/or a touch input layer 345) and in some embodiments maintains or updates the virtual shopping cart. For example, the transaction module 320 may access a current version of the virtual shopping cart via the network 365, and may receive one or more inputs via the touch input layer 335 and/or the touch input layer 345 to update the virtual shopping cart (e.g., by adding or removing selected items to the virtual shopping cart).

Using the network 365, the payment module 325 performs electronic payment processing associated with electronically completing the sale transaction. For example, the payment module 325 may perform steps associated with completing credit card authorizations, online money transfers, and so forth.

The display device 330-1 comprises a touch input layer 335 that overlaps a display layer 340. The display device 330-2 comprises a touch input layer 345 that overlaps a display layer 350. In some embodiments, the display devices 330-1, 330-2 are implemented as distinct devices that are physically attached and/or housed together. In other embodiments, the display devices 330-1, 330-2 are formed as a single device. Although not shown, the display devices 330-1, 330-2 may include additional components, such as one or more computer processors that are configured to operate the respective touch input layers 335, 345 and the display layers 340, 350 in accordance with signals received from the computing device 305. For example, the one or more computer processors may include driver circuitry and measurement circuitry to support the display and touch input functions of the display devices 330-1, 330-2.

The touch input layers 335, 345 may utilize any combination of sensor components and sensing technologies to detect user inputs at or near the top surface 205. For example, each touch input layer 335, 345 comprises a plurality of sensor electrodes for detecting user input. As several non-limiting examples, the touch input layers 335, 345 may use capacitive, elastive, resistive, inductive, magnetic, acoustic, ultrasonic, and/or optical techniques, and may include combinations thereof.

The display layers 340, 350 may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology or technologies. In some embodiments, the display layer 340 and/or the display layer 350 may be selectively optically transmissive, such as an OLED, a side-lit LCD, or a naturally-lit LCD. In some embodiments, both the display layer 340 and the display layer 350 are selectively optically transmissive. In other embodiments, the display layer 340 is selectively optically transmissive and the display layer 350 is not optically transmissive.

The display layers 340, 350 may include a plurality of display electrodes used for updating the display, such as common electrode(s), source drive line(s), gate line(s), anode sub-pixel electrode(s) or cathode pixel electrode(s), or any other suitable display element(s). The plurality of display electrodes may be disposed on a substrate, which in some cases is formed of an optically transmissive material such as glass. In some embodiments, the touch input layers 335, 345 and the display layers 340, 350 may share physical elements. For example, some embodiments may utilize some of the same electrical components for displaying and sensing.

Some or all of the touch input layers 335, 345 and the display layers 340, 350 may be optically transmissive. In some embodiments, the plurality of sensor electrodes and/or the plurality of display electrodes may be formed of optically transmissive material, e.g., an optically transmissive film material such as indium tin oxide (ITO). The optically transmissive film material may be optically transmissive both at macroscopic and microscopic scales.

In other embodiments, the plurality of sensor electrodes and/or the plurality of display electrodes may be formed of a metal mesh material of copper or another suitably conductive metal that is not itself optically transmissive. For example, the plurality of sensor electrodes and/or the plurality of display electrodes may comprise relatively thin lines of the metal mesh material (e.g., between about 1 and about 10 microns wide). In some embodiments, the thin lines of the metal mesh material are spaced apart to form a plurality of interstitial spaces, which provide the substantially optically transmissive property to the metal mesh material when viewed on a macroscopic scale.

Due to the (selectively) optically transmissive qualities of the touch input layer 335, the touch input layer 345, the display layer 340, and/or the display layer 350, imagery 355-1 that is generated by the display layer 340 is transmitted through the touch input layer 335 and the top surface 205 and viewable by a user. The imagery 355-2 that is generated by the display layer 350 is transmitted through the touch input layer 345, the display layer 340, the touch input layer 335, and the top surface 205 and also viewable by the user.

Although an implementation is described in which the display device 330-2 that selectively displays the payment UI element(s) is arranged beneath the display device 330-1 that selectively displays graphical element(s), an alternate implementation may have the display device 330-2 arranged above the display device 330-1. Further, although described primarily in terms of a discrete self-checkout system as in FIG. 1, the features described herein may be implemented in other suitable forms. In one non-limiting example, the touch input layers 335, 345 and the display layers 340, 350 may be attached to (or integrated into) glass storefront windows. In some cases, when the one or more payment UI elements are not displayed, the display layer 340 or the display layer 350 may display advertising or other information.

In some embodiments, security considerations may require isolation of hardware systems supporting different functions. For example, the Payment Card Industry (PCI) Security Standards Council maintains a PCI Data Security Standard (DSS) to ensure that credit card information entered by a customer is securely processed, stored, and transmitted. To ensure PCI DSS compliance, the self-checkout system may isolate a payment system (e.g., credit card reader and/or pinpad) from the other hardware of the point-of-sale (POS) terminal.

In some embodiments, the transaction module 320 and the payment module 325 may be implemented in separate, isolated hardware of the computing device 305, or in different computing devices. In one example, the display device 330-1 is connected with a first computing device via the communicative link 360-1, and the display device 330-2 is connected with a second computing device via the communicative link 360-2.

In some embodiments, the touch input layers 335 and 345 may be selectively enabled and/or disabled by the computing device 305 to effectively maintain the isolation of the hardware systems. For example, while the transaction module 320 is operating to display one or more graphical elements using the display layer 340, the computing device 305 may enable the touch input layer 335 to receive inputs to maintain and/or update the virtual shopping cart. While the touch input layer 335 is enabled, the computing device 305 may disable the touch input layer 345 to prevent the user inputs to the touch input layer 335 being registered by the touch input layer 345.

While the payment module 325 is operating to display one or more payment UI elements using the display layer 350, the computing device 305 may enable the touch input layer 345 to receive inputs to electronically complete the sale transaction. While the touch input layer 345 is enabled, the computing device 305 may disable the touch input layer 335 to prevent the user inputs to the touch input layer 345 being registered by the touch input layer 335.

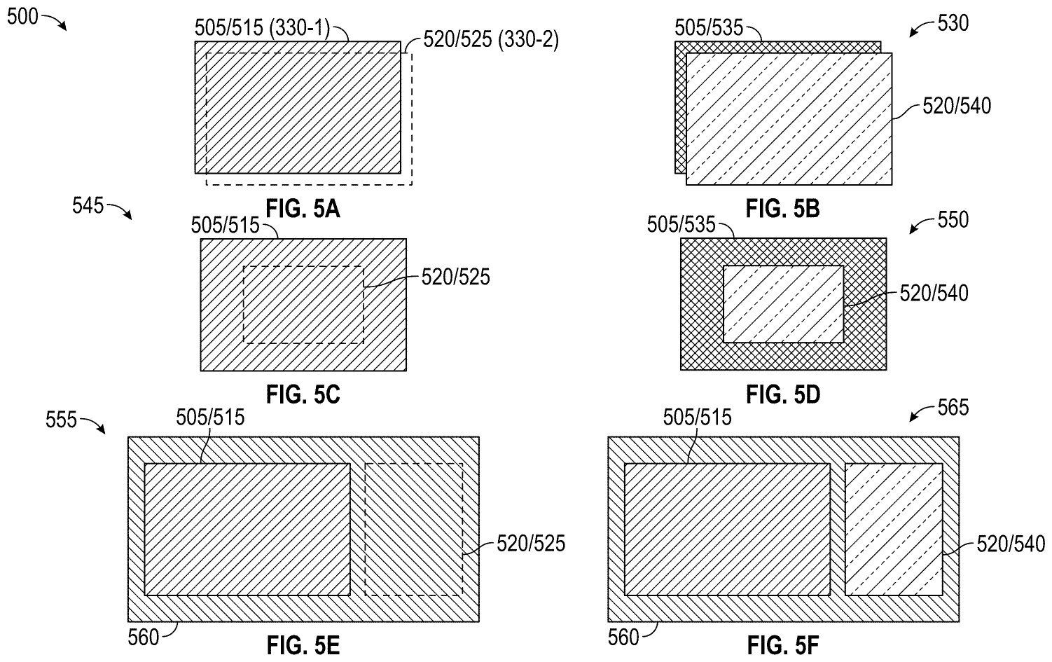

FIG. 4 is a block diagram of a system 400 having a shared touch input layer 335, according to one or more embodiments. The system 400 may be used in conjunction with other embodiments. For example, the system 400 may represent one implementation of the display system 105 and the payment receiver 115 of FIG. 1.

The system 400 comprises a touch input device 405 and the display devices 330-1, 330-2. The touch input device 405 comprises the touch input layer 335. In some embodiments, the display devices 330-1, 330-2 are implemented as distinct devices from the touch input device 405 that are physically attached and/or housed together. In other embodiments, the display devices 330-1, 330-2 and the touch input device 405 are formed as a single device.

The system 400 further comprises a switch 410 that is connected to the computing device 305 via a communicative link 415. The switch 410 may have any suitable implementation, such as a transistor, a multiplexer, or the like. Further, the switch may be internal to the computing device 305 or external to the computing device 305. The communicative link 415 may have any suitable implementation, such as copper transmission cable(s), optical transmission fiber(s), wireless transmission, router(s), firewall(s), switch(es), gateway computer(s), and/or edge server(s).

In some embodiments, the computing device 305 transmits control signals to the switch 410 to selectively couple the touch input device 405 to the display device 330-1 or the display device 330-2.

For example, while the transaction module 320 is operating to display one or more graphical elements using the display layer 340, the computing device 305 may control the switch 410 to couple the touch input device 405 to a processor of the display device 330-1 to receive inputs to maintain and/or update the virtual shopping cart. While the touch input device 405 is coupled to the display device 330-1, the touch input device 405 is decoupled from the processor of the display device 330-2 to prevent the user inputs to the touch input device 405 being registered by the display device 330-2.

While the payment module 325 is operating to display one or more payment UI elements using the display layer 350, the computing device 305 may control the switch 410 to couple the touch input device 405 to a processor of the display device 330-2 to receive inputs to electronically complete the sale transaction. While the touch input device 405 is coupled to the display device 330-2, the touch input device 405 is decoupled from the processor of the display device 330-1 to prevent the user inputs to the touch input device 405 being registered by the display device 330-1.

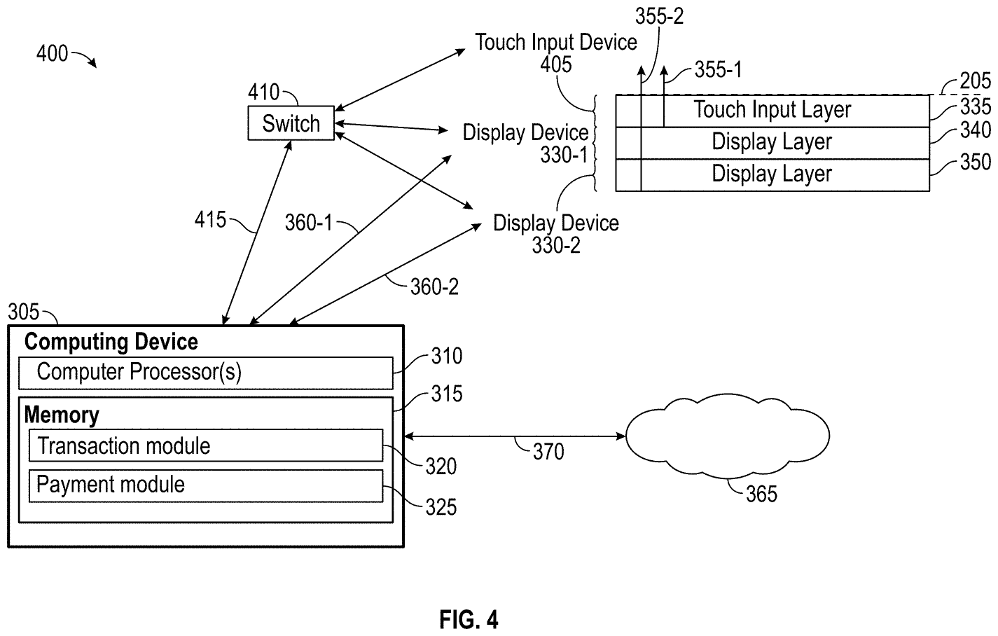

FIGS. 5A, 5B, 5C, 5D, 5E, 5F illustrate arrangements of active areas of overlapping display devices. The features illustrated in FIGS. 5A, 5B, 5C, 5D, 5E, 5F may be used in conjunction with other embodiments.

In diagram 500 of FIG. 5A, an active area 505 of the display device 330-1 is coextensive with an active area 520 of the display device 330-2 (although illustrated as slightly offset for easier viewing). The active area 505 is in an active display state 515, e.g., displaying one or more graphical elements during checkout, while the active area 520 is in an inactive display state 525. Responsive to an input signaling that the sale transaction is to be electronically completed, the display devices 330-1, 330-2 may be transitioned into the arrangement of diagram 530 of FIG. 5B. In the diagram 530, the active area 505 is in a deemphasized display state 535 (e.g., where the one or more graphical elements are grayed or blacked out) and the active area 520 is in an active display state 540, e.g., displaying one or more payment UI elements to electronically complete the sale transaction.

In diagram 545 of FIG. 5C, the active areas 505, 520 are overlapping and non-coextensive. More specifically, the active area 505 is larger than the active area 520. The active area 505 is in an active display state 515 while the active area 520 is in an inactive display state 525. Responsive to the input signaling that the sale transaction is to be electronically completed, the display devices 330-1, 330-2 may be transitioned into the arrangement of diagram 550 of FIG. 5D. In the diagram 550, the active area 505 is in the deemphasized display state 535 and the active area 520 is in the active display state 540.

In diagram 555 of FIG. 5E, the active areas 505, 520 are non-overlapping. The active area 505 is in an active display state 515 while the active area 520 is in an inactive display state 525. Responsive to the input signaling that the sale transaction is to be electronically completed, the display devices 330-1, 330-2 may be transitioned into the arrangement of diagram 565 of FIG. 5F. In the diagram 565, the active area 505 is in the active display state 515 and the active area 520 is in the active display state 540. The active area 520 is viewable through an optically transmissive portion 560 of the display device 330-1 that overlaps the active area 520.

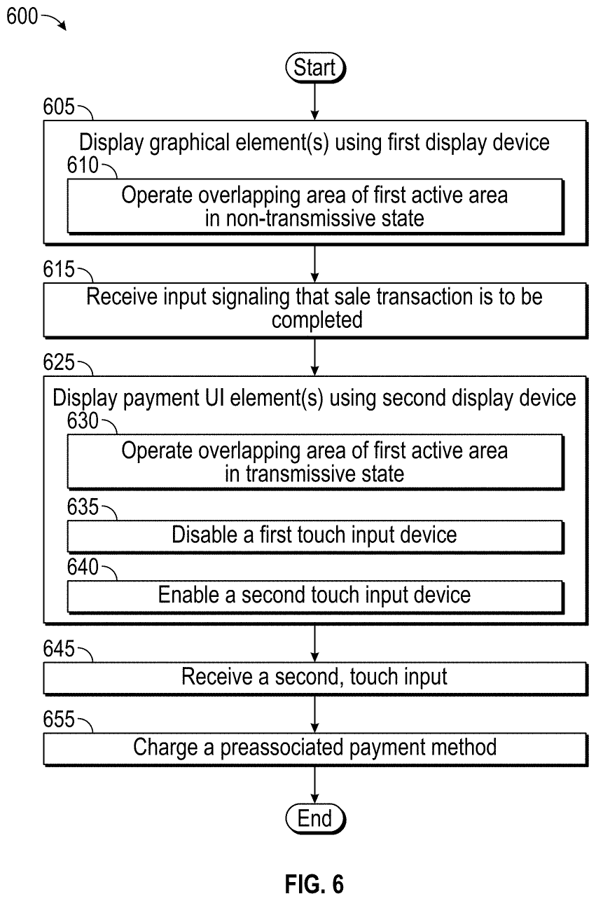

FIG. 6 is a method 600 of performing a sale transaction, according to one or more embodiments. The method 600 may be used in conjunction with other embodiments, such as operating a self-checkout system as in FIGS. 2A-2D.

The method 600 begins at block 605, where one or more graphical elements are displayed using a first display device. In some embodiments, displaying the one or more graphical elements comprises (at block 610) operating an overlapping area of a first active area of the first display device in a non-transmissive state. At block 615, the self-checkout system receives an input signaling that the sale transaction is to be electronically completed.

At block 625, one or more payment UI elements are displayed using a second display device overlapped by the first display device. In some embodiments, displaying the one or more payment UI elements comprises (at block 630) operating the overlapping area of the first active area in a transmissive state, permitting the one or more payment UI elements to be viewable through the first display device. In some embodiments, displaying the one or more payment UI elements comprises (at block 635) disabling a first touch input device and (at block 640) enabling a second touch input device.

At block 645, the self-checkout system receives a second, touch input (e.g., to electronically complete the sale transaction). At block 655, the self-checkout system charges a payment method that is preassociated with the user (e.g., completing a credit card authorization or an online money transfer). The method 600 ends following completion of the block 655.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements described herein, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages described herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A system for electronic completion of a transaction, the system comprising:
a first display device;
a second display device that is at least partly overlapped by the first display device;
a touch input device; and
one or more computer processors configured to:
display one or more graphical elements using the first display device;
display, responsive to a first input signaling that the transaction is to be electronically completed, one or more user interface (UI) elements using the second display device, wherein the one or more UI elements are viewable through an optically transmissive portion of the first display device; and
receive, using the touch input device, at least a second input while the one or more UI elements are displayed.

2. The system of claim 1,
wherein the transaction is a sale transaction, and
wherein the one or more UI elements comprise payment UI elements.

3. The system of claim 1,
wherein an overlapping area of a first active area of the first display device overlaps a second active area of the second display device,
wherein the first active area is selectively optically transmissive,
wherein displaying the one or more graphical elements comprises operating the overlapping area of the first active area in a non-transmissive state, and
wherein displaying the one or more UI elements comprises operating the overlapping area of the first active area in a transmissive state.

4. The system of claim 3, wherein the first display device comprises one of the following:
an organic light-emitting diode (OLED),
a side-lit liquid crystal display (LCD), and
a naturally-lit LCD.

5. The system of claim 1, wherein an optically transmissive portion of the first display device overlaps an active area of the second display device.

6. The system of claim 1, wherein displaying the one or more UI elements comprises at least one of the following:
disabling the first display device;
freezing the one or more graphical elements displayed by the first display device; or
deemphasizing the one or more graphical elements displayed by the first display device.

7. The system of claim 1,
wherein displaying the one or more UI elements comprises disabling a first touch input device of the first display device, and
wherein the touch input device is a second touch input device of the second display device.

8. The system of claim 1, wherein displaying the one or more UI elements comprises:
decoupling the touch input device from a processor of the first display device; and
coupling the touch input device to a processor of the second display device.

9. A computer-implemented method of electronic completion of a transaction, the method comprising:
displaying, using a first display device, one or more graphical elements;
receiving a first input signaling that the transaction is to be electronically completed;
displaying, responsive to the first input, one or more user interface (UI) elements using a second display device that is at least partly overlapped by the first display device, wherein the one or more UI elements are viewable through an optically transmissive portion of the first display device; and
receiving, using a touch input device, at least a second input while the one or more UI elements are displayed.

10. The method of claim 9,
wherein the transaction is a sale transaction, and
wherein the one or more UI elements comprise payment UI elements.

11. The method of claim 9,
wherein an overlapping area of a first active area of the first display device overlaps a second active area of the second display device,
wherein the first active area is selectively optically transmissive,
wherein displaying the one or more graphical elements comprises operating the overlapping area of the first active area in a non-transmissive state, and
wherein displaying the one or more UI elements comprises operating the overlapping area of the first active area in a transmissive state.

12. The method of claim 9, wherein displaying the one or more UI elements comprises at least one of the following:
disabling the first display device;
freezing the one or more graphical elements displayed by the first display device; or
deemphasizing the one or more graphical elements displayed by the first display device.

13. The method of claim 9,
wherein displaying the one or more UI elements comprises disabling a first touch input device of the first display device, and
wherein the touch input device is a second touch input device of the second display device.

14. The method of claim 9, wherein displaying the one or more UI elements comprises:
decoupling the touch input device from a processor of the first display device; and
coupling the touch input device to a processor of the second display device.

15. A computer program product for electronic completion of a transaction, the computer program product comprising:
a computer-readable storage medium having computer-readable program code, the computer-readable program code executable by one or more computer processors to perform an operation that comprises:
displaying, using a first display device coupled with the one or more computer processors, one or more graphical elements;
receiving a first input signaling that the transaction is to be electronically completed;
displaying, responsive to the first input, one or more user interface (UI) elements using a second display device coupled with the one or more computer processors and that is at least partly overlapped by the first display device, wherein the one or more UI elements are viewable through an optically transmissive portion of the first display device; and
receiving, using a touch input device coupled with the one or more computer processors, at least a second input while the one or more UI elements are displayed.

16. The computer program product of claim 15,
wherein the transaction is a sale transaction, and
wherein the one or more UI elements comprise payment UI elements.

17. The computer program product of claim 15,
wherein an overlapping area of a first active area of the first display device overlaps a second active area of the second display device,
wherein the first active area is selectively optically transmissive,
wherein displaying the one or more graphical elements comprises operating the overlapping area of the first active area in a non-transmissive state, and
wherein displaying the one or more UI elements comprises operating the overlapping area of the first active area in a transmissive state.

18. The computer program product of claim 15, wherein displaying the one or more UI elements comprises at least one of the following:
disabling the first display device;
freezing the one or more graphical elements displayed by the first display device; or
deemphasizing the one or more graphical elements displayed by the first display device.

19. The computer program product of claim 15,
wherein displaying the one or more UI elements comprises disabling a first touch input device of the first display device, and
wherein the touch input device is a second touch input device of the second display device.

20. The computer program product of claim 15, wherein displaying the one or more UI elements comprises:
decoupling the touch input device from a processor of the first display device; and
coupling the touch input device to a processor of the second display device.
